(19) United States
(12) Patent Application Publication
(10) Pub. No.: US 2013/0238988 A1
(43) Pub. Date: Sep. 12, 2013

(54) COMPUTING DEVICE AND METHOD OF SUPPORTING MULTI-LANGUAGES FOR APPLICATION SOFTWARE

(71) Applicants: HONG FU JIN PRECISION INDUSTRY (ShenZhen) CO., LTD., (US); HON HAI PRECISION INDUSTRY CO., LTD., New Taipei (TW)

(72) Inventors: CHUNG-I LEE, New Taipei (TW); HAI-HONG LIN, Shenzhen (CN); DE-YI XIE, Shenzhen (CN); JIE HUANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/751,017

(22) Filed: Jan. 25, 2013

(30) Foreign Application Priority Data
Mar. 8, 2012 (CN) 201210059198.1

(51) Int. Cl. G06F 17/24

(52) U.S. Cl. CPC G06F 17/24
USPC 715/264

(57) ABSTRACT

In a method of supporting multi-languages for an application software of a computing device, one or more content to be displayed on a user interface of the application software are searched from program codes of the application software, and a location of the displayed content located in the program codes is recorded. The displayed content is translated using multiple languages, a source document for the translated content corresponding to each of the languages is generated, and all source documents are stored into a program library of the application software. The source document from the program library are loaded when a language is selected from the user interface, and the displayed content is replaced with the translated content in the program codes of the application software. The user interface in form of the selected language is displayed on a display device when the application software is executed.

### BACKGROUND

1. Technical Field

Embodiments of the present disclosure relate to software programming systems and methods, and particularly to a computing device and a method of supporting multi-languages for an application software of the computing device.

2. Description of Related Art

Application software systems may provide multiple languages, such as English, Spanish, Japanese or Chinese, for different language users to use. During design an application software system, one or more content may be embedded in program codes of an application software system, and may be displayed on user interfaces of the application software system using the different languages. However, programming designers must repeatedly design program codes of the application software system using different programming languages for the content displayed on the user interfaces of the application software system. Such design wastes computing resources and time, and increases complexity for maintenance of the program codes of the application software system.

### BRIEF DESCRIPTION OF THE DRAWINGS

FIG. 1 is a block diagram of one embodiment of a computing device including a multi-languages support system.

FIG. 2 is a block diagram illustrating function modules of the multi-languages support system of FIG. 1.

FIG. 3 is a flowchart of one embodiment of a method of supporting multi-languages for an application software of the computing device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage system. Some non-limiting examples of a non-transitory computer-readable medium include CDs, DVDs, flash memory, and hard disk drives.

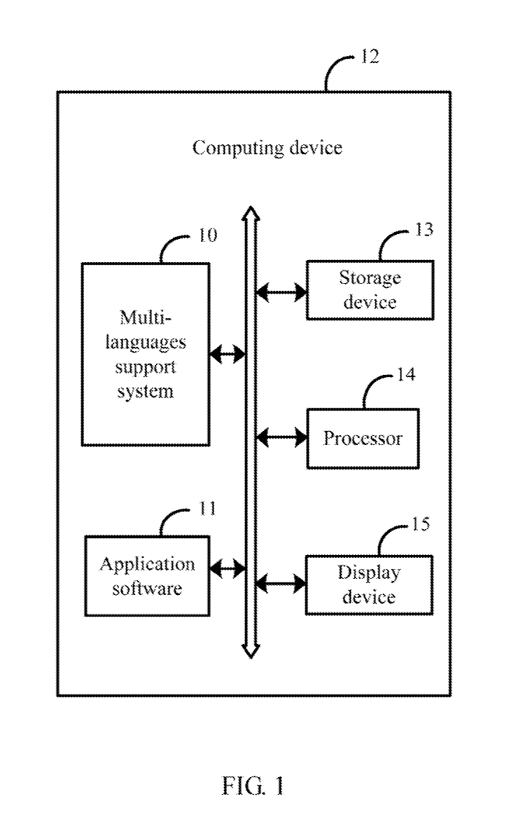

FIG. 1 is a block diagram of one embodiment of a computing device 12 including a multi-languages support system 10. In the embodiment, the computing device 1 may further include an application software 11, a storage device 13, at least one processor 14, and a display device 15. The computing device 1 may be a host computer, a workstation computer, or a server computer. In the embodiment, the multi-languages support system 10 may include computerized instructions in the form of one or more programs that are stored in the storage device 13 and executed by the at least one processor 14. It should be understood that FIG. 1 illustrates only one example of the computing device 1 that may include more or fewer components than illustrated, or have a different configuration of the various components in other embodiments.

The application software 11 may provide a plurality of user interfaces to display content on the display device 15 using different languages, such as English, Spanish, Japanese, or Chinese, for different users. The content may include, but is not limited to, menu items, icons, images, and letters. In one embodiment, the storage device 13 may be an internal storage system, such as a random access memory (RAM) for temporary storage of information, and/or a read only memory (ROM) for permanent storage of information. In some embodiments, the storage device 13 may also be an external storage system, such as an external hard disk, a storage card, or a data storage medium.

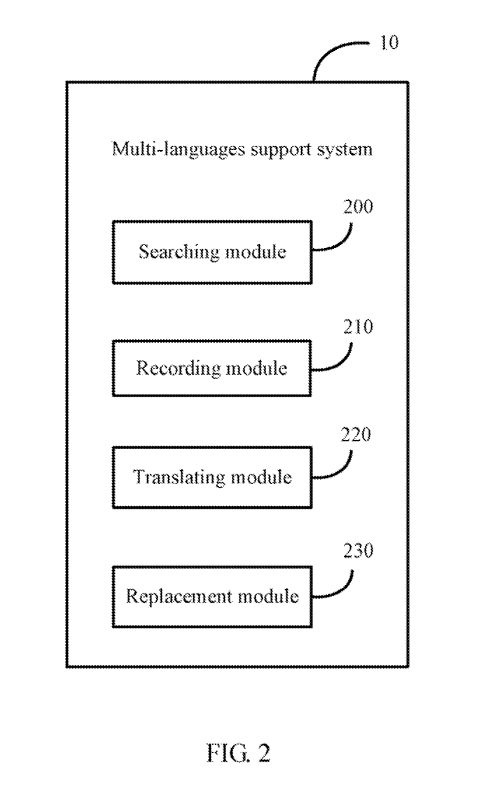

FIG. 2 is a block diagram illustrating function modules of the multi-languages support system 10. In one embodiment, the multi-languages support system 10 includes a searching module 101, a recording module 102, and a translating module 103, and a replacement module 104. The modules 101-104 may comprise computerized instructions in the form of one or more programs that are stored in the storage device 13 and executed by the at least one processor 14.

The searching module 101 is configured for searching content to be displayed on a user interface of the application software 11 from program codes of the application software 11. In one embodiment, the displayed content may include, but is not limited to, menu items, icons, images, and letters. The displayed content may be embedded in the program codes of the application software 11, and have an identification code programmed in the program codes of the application software 11. The searching module 101 searches the displayed content from the program codes of the application software 11 according to the identification code of the displayed content.

The recording module 102 is configured for recording a location of the displayed content located in the program codes of the application software 11. For example, the recording module 102 may add a marked tag in the identification code of the displayed content to record the location of the displayed content.

The translating module 103 is configured for translating the displayed content into translated content using a plurality of languages, generating a source document for the translated content corresponding to each of the languages, and storing all of the source documents into a program library of the application software 11. The languages include, but not limited to, English, Spanish, Japanese, and Chinese. Each of the source documents is stored in the program library in form of an extensible markup language (XML) format. For example, if the user uses the application software in Chinese, the translating module 103 translates the displayed content of the application software 11 into Chinese content, generates a Chinese source document for the Chinese source content, and then stores the Chinese source document into the program library.

The replacement module 104 is configured for loading a source document of the application software 11 from the program library according to a language selected from the user interface, replacing the displayed content with the translated content in the program codes of the application software 11 according to the location and the source document. The replacement module 104 is further configured for displaying on the user interface in form of the selected language on the display device 15 when the application software 11 is executed. For example, if the user selects Chinese to be used as a display language of the application software from the user interface, the replacement module 104 searches the Chinese source document from the program library, replaces the displayed content with the Chinese content using the Chinese source document, and displays the Chinese content on the user interface.

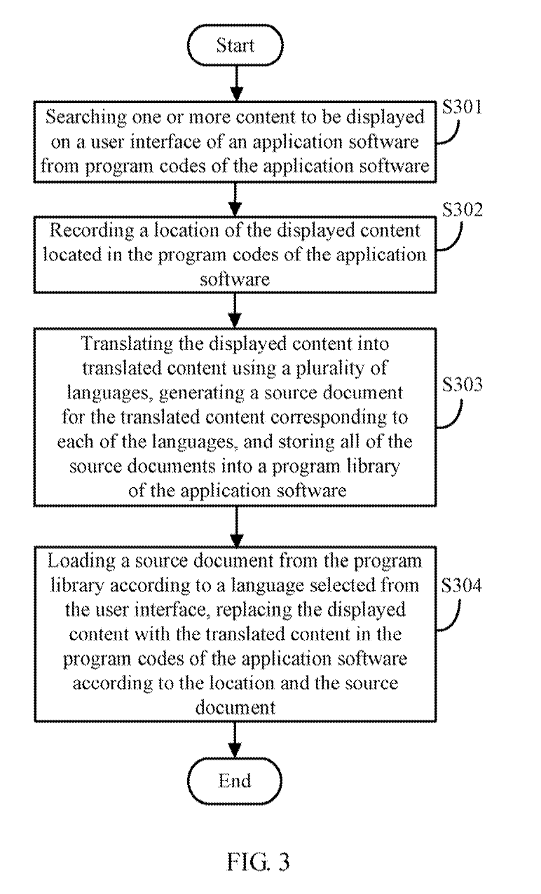

FIG. 3 is a flowchart of one embodiment of a method of supporting multi-languages for the application software 11 of the computing device 12 of FIG. 1. Depending on the embodiment, additional steps may be added, others removed, and the ordering of the steps may be changed.

In step S301, the searching module 101 searches content to be displayed on a user interface of the application software 11 from program codes of the application software 11. In one embodiment, the displayed content may be, but is not limited to, menu items, icons, images, and letters. The displayed content may be embedded in the program codes of the application software 11, and have an identification code programmed in the program codes of the application software 11. The searching module 101 searches the displayed content from the program codes of the application software 11 according to the identification code of the displayed content.

In step S302, the recording module 102 records a location of the displayed content located in the program codes of the application software 11. For example, the recording module 102 may add a marked tag in the identification code of the displayed content to record the location of the displayed content.

In step S303, the translating module 103 translates the displayed content into translated content using a plurality of languages, generates a source document for the translated content corresponding to each of the languages, and stores all of the source document into a program library of the application software 11. The languages include, but not limited to, English, Spanish, Japanese, and Chinese. For example, if the user uses the application software in Chinese, the translating module 103 translates the displayed content of the application software 11 into Chinese content, generates a Chinese source document for the Chinese source content, and then stores the Chinese source document into the program library.

In step S304, the replacement module 104 loads a source document from the program library according to a language selected from the user interface, replaces the displayed content with the translated content in the program codes of the application software 11 according to the location and the source document. For example, if the user selects Chinese from the user interface, the replacement module 104 searches the Chinese source document from the program library, and replaces the displayed content with the Chinese content using the Chinese source document. When the application software 11 is executed, the replacement module 104 displays the user interface in form of the selected language on the display device 15.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
application software;
a storage device;
at least one processor; and
one or more programs stored in the storage device and executed by the at least one processor, the one or more programs comprising:
a searching module configured for searching one or more content to be displayed on a user interface of the application software from program codes of the application software;
a recording module configured for recording a location of the displayed content located in the program codes of the application software;
a translating module configured for translating the displayed content into translated content using a plurality of languages, generating a source document for the translated content corresponding to each of the languages, and storing all of the source documents into a program library of the application software; and
a replacement module configured for loading a source document from the program library according to a language selected from the user interface, replacing the displayed content with the translated content in the program codes of the application software according to the location and the source document, and displaying the user interface in form of the selected language on a display device when the application software is executed.

2. The computing device according to claim 1, wherein the displayed content is embedded in the program codes of the application software, and have an identification code programmed in the program codes of the application software.

3. The computing device according to claim 2, wherein the searching module searches the displayed content from the program codes of the application software according to the identification code of the displayed content.

4. The computing device according to claim 2, wherein the recording module adds a marked tag in the identification code of the displayed content to record the location of the displayed content.

5. The computing device according to claim 1, wherein each of the source documents is stored in the program library in form of an extensible markup language (XML) format.

6. A method of supporting multi-languages for an application software of a computing device, the method comprising:
searching one more content to be displayed on a user interface of the application software from program codes of the application software;
recording a location of the displayed content located in the program codes of the application software;
translating the displayed content into translated content using a plurality of languages;
generating a source document for the translated content corresponding to each of the languages, and storing all of the source documents into a program library of the application software;
loading a source document from the program library according to a language selected from the user interface, and replacing the displayed content with the translated content in the program codes of the application software according to the location and the source document; and
displaying the user interface in form of the selected language on a display device when the application software is executed.

7. The method according to claim 6, wherein the displayed content is embedded in the program codes of the application software, and have an identification code programmed in the program codes of the application software.

8. The method according to claim 7, wherein the displayed content from the program codes of the application software are searched according to the identification code of the displayed content.

9. The method according to claim 7, wherein the location of the displayed content is recorded by adding a marked tag in the identification code of the displayed content.

10. The method according to claim 6, wherein each of the source documents is stored in the program library in form of an extensible markup language (XML) format.

11. A non-transitory storage medium having stored thereon instructions that, when executed by at least one processor of a computing device, causes the computing device to perform a method of supporting multi-languages for an application software of the computing device, the method comprising:
searching one or more content to be displayed on a user interface of the application software from program codes of the application software;
recording a location of the displayed content located in the program codes of the application software;
translating the displayed content into translated content using a plurality of languages;
generating a source document for the translated content corresponding to each of the languages, and storing all of the source documents into a program library of the application software;
loading a source document from the program library according to a language selected from the user interface, and replacing the displayed content with the translated content in the program codes of the application software according to the location and the source document; and
displaying the user interface in form of the selected language on a display device when the application software is executed.

12. The storage medium according to claim 11, wherein the displayed content is embedded in the program codes of the application software, and have an identification code programmed in the program codes of the application software.

13. The storage medium according to claim 12, wherein the displayed content from the program codes of the application software are searched according to the identification code of the displayed content.

14. The storage medium according to claim 12, wherein the location of the displayed content is recorded by adding a marked tag in the identification code of the displayed content.

15. The storage medium according to claim 11, wherein each of the source documents is stored in the program library in form of an extensible markup language (XML) format.
